(19) United States
(12) Patent Application Publication
(10) Pub. No.: US 2003/0204337 A1
(43) Pub. Date: Oct. 30, 2003

(54) Method and apparatus for operating an electrical data bus system

(75) Inventor: Klaus Beutelschiess, Dettingen (DE)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems AG, Kirchheim - Nabern (DE)

(21) Appl. No.: 10/323,586

(22) Filed: Dec. 18, 2002

(30) Foreign Application Priority Data
Dec. 18, 2001 (DE) 10161996.0

(51) Int. Cl. G01L 7/00; G01N 11/00; G01F 17/00; G06F 19/00; G01F 23/00

(52) U.S. Cl. 702/51

(57) ABSTRACT

An electrical data bus system comprises at least one monitoring device for detecting leakage of a flammable gas within a fuel zone. Pursuant to the method, upon a flammable gas leak within the fuel zone being detected, the flow of electrical current in the fuel zone, via the data bus system or any device connected to the data bus system, is prevented.

### BACKGROUND OF THE INVENTION

1. Field of the Invention

The invention relates to a method and apparatus for operating an electrical data bus system. More specifically, the invention relates to a method and apparatus for operating an electrical data bus system comprising at least one monitoring device, such as a sensor, for detecting leakage of a flammable gas.

2. Description of the Related Art

The use of fuel cell technology as an alternative engine concept for vehicles is well known. Fuel cells generally operate by electrochemically converting an oxygen-rich gas and a hydrogen-rich gas into electrical current. The use of this technology therefore requires that the vehicle be provided with hydrogen fuel. Often, for reasons related to the configuration of the fuel cell system, the fuel cannot be confined to a single location within the vehicle. Indeed, fuel lines and fuel cell related components may result in hydrogen being present in many vehicle locations, such as for example near a tank, an engine compartment, a fuel processing system or reformer, or near a battery. Locations in a vehicle that may be subject to a potential discharge of hydrogen are referred to as fuel zones.

For safety reasons, it is therefore advisable to continuously monitor the fuel zones of a vehicle for leakage, since hydrogen-rich gases are typically flammable. For this purpose, hydrogen sensors are typically used to detect local hydrogen concentrations; hydrogen sensors typically determine hydrogen content by measuring the thermal conductivity of the surrounding environment.

German Patent Application No. 1961 1944 A1 describes a data bus system, in which networked controllers form a “Controller Area Network (CAN)”, which uses protocol-based communication through an electrical two-wire line. A voltage regulator provides voltage to the controllers and the data bus.

In a vehicle, it is desirable to connect hydrogen sensors via a data bus system so as to achieve an optimal processing of the fault signals coming from the sensors located in fuel zones, as well as an improved reliability in such zones. Connected via a data bus system, the hydrogen sensors can provide information on size and position a fuel leak within the vehicle. This information can be passed on to any desired controller by means of the data bus.

A disadvantage of this method is that the sensors and controllers, as well as the data bus, are continuously provided with electrical power. This results in electricity being available at the location of the leak, which could potentially lead to ignition of the flammable gas being monitored.

There is therefore a need for a method of operating an electrical data bus system, comprising sensors and controllers for monitoring fuel zones for the presence of a flammable gas, which addresses the above-mentioned disadvantage. There is also a need for an apparatus for addressing the above-mentioned disadvantage.

### BRIEF SUMMARY OF THE INVENTION

A method is provided for operating an electrical data bus system, which controls at least one monitoring device for detecting a flammable gas leak within a fuel zone. Upon a flammable gas leak within the fuel zone being detected, the flow of electrical current in the fuel zone, via the data bus system or any device connected to the data bus system, is prevented.

The step of preventing the flow of electrical current in the fuel zone can be accomplished by disconnecting, from the data bus, monitoring devices, which deliver electrical signals to or receive electrical signals from the data bus.

The step of preventing the flow of electrical current in the fuel zone can also be accomplished by having the monitoring devices, which deliver electrical signals to or receive electrical signals from the data bus, disconnect themselves from the data bus.

The step of preventing the flow of electrical current in the fuel zone can also be accomplished by grounding the data bus.

The step of preventing the flow of electrical current in the fuel zone can also be accomplished by disconnecting monitoring devices, located within the fuel zone, from their power supply.

The step of preventing the flow of electrical current in the fuel zone can also be accomplished by turning off the power supply of monitoring devices located within the fuel zone.

The method may comprise the further step of testing the level of flammable gases within the fuel zone before reconnecting the monitoring devices to the data bus and/or before reconnecting the monitoring devices, located within the fuel zone, to their power supply and/or before turning the power supply of the monitoring devices, located within the fuel zone, back on.

A computer program product with program code stored on a machine-readable carrier is also provided. The computer program executes the method outlined above when the program is running on a computer.

A digital storage medium with control signals that can be read out electronically is also provided. The control signals are able to interact and/or cooperate with a programmable computer system such that the method described above is carried out.

An apparatus for detecting a flammable gas leak within a fuel zone comprises:

an electrical data bus system; and

a monitoring device, delivering electrical signals to or receiving electrical signals from the data bus system, for detecting a flammable gas leak within the fuel zone,

wherein, the apparatus is configured so that upon a flammable gas leak within the fuel zone being detected, the flow of electrical current in the fuel zone is prevented.

The apparatus may further comprise a control device, connected to the data bus system, for disconnecting, from the data bus, the monitoring device. The control device can further prevent the monitoring device from being re-connected to the data bus system until the concentration of flammable gas within the fuel zone is at an acceptable level.

The monitoring device may have the ability to disconnect itself from the data bus system. In such an embodiment, the apparatus may further comprise a control device, connected to the data bus system, for preventing the monitoring device from reconnecting itself to the data bus system until the concentration of flammable gas within the fuel zone is at an acceptable level.

The apparatus may further comprise a control device, connected to the data bus system, for grounding the data bus system.

The apparatus may further comprise a control device, connected to the data bus system, for disconnecting the monitoring device from its power supply. The control device may further prevent the monitoring device from being re-connected to its power supply until flammable gases are no longer present within the fuel zone.

The monitoring device may have the ability to shut off its power supply. In such an embodiment, the apparatus may further comprise a control device, connected to the data bus system, for preventing the monitoring device from activating their power supply until the concentration of flammable gas within the fuel zone is at an acceptable level.

Many specific details of certain embodiments of the invention are set forth in the detailed description below to provide a thorough understanding of such embodiments. One skilled in the art, however, will understand that the present invention may have additional embodiments, or may be practised without several of the details described

### BRIEF DESCRIPTION OF THE DRAWINGS

FIG. 1 shows an embodiment of an electrical data bus system, comprising sensors and controllers for detecting leakage of flammable gases, which can be operated by a method according to the invention.

### DETAILED DESCRIPTION OF THE INVENTION

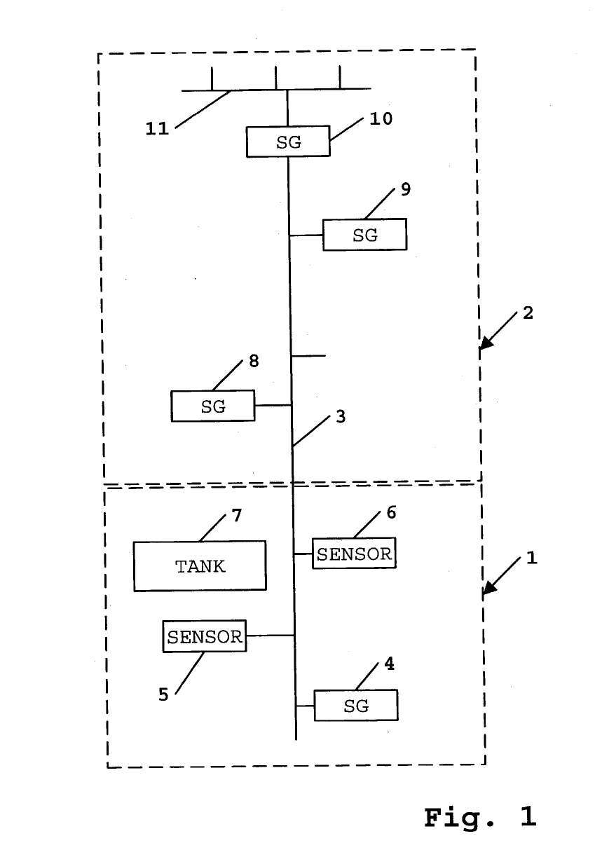

FIG. 1 shows schematically a data bus system 3, extending through two zones of a vehicle, a fuel zone 1 and a normal zone 2. A hydrogen tank 7 is located in fuel zone 1. Fuel zone 1 is monitored for possible leak from hydrogen tank 7 by means of hydrogen sensors 5, 6. Fuel zone 1 is therefore the zone that may be subject to possible leakage of a flammable gas.

In the current embodiment, a controller 4 is also located in fuel zone 1; this reflects a common occurrence in vehicles, where space is at a premium and multiple components are located in close proximity to one another.

Data bus 3 connects fuel zone 1 with normal zone 2. Normal zone 2 contains further controllers 8, 9, 10, whereby controller 10 connects data bus 3 with a further data bus 11 in the vehicle. The extent of data bus 3 may be limited to fuel zone 1, or, as shown in FIG. 1, extend through fuel zone 1 and normal zone 2.

The connection of data bus 3 to a further data bus in the vehicle is not important for the application of the method according to the invention (but is often found in real-life applications). For reasons of increased safety, data bus 3, which monitors fuel leakage, is desirably electrically and/or physically isolated from other data busses of the vehicle. Data bus 3 may be configured in a star or a ring pattern. The star configuration, in particular, is very suitable for decoupling individual branches from the main bus system.

In the current embodiment, data bus system 3 is a CAN bus; it should however be noted that the method according to the invention can be used with various other electrical bus systems, such as for example, a FlexRay or TTP/C (Time Triggered Protocol). In addition to their specific micro-controller properties, controllers 4, 8, 9, 10 and sensors 5, 6 include the necessary components to communicate through the CAN bus, such as an analog-digital converter, a voltage regulator as power supply unit, as well as a CAN interface (as the actual communication interface with the bus). The CAN interface includes a transmitting and receiving unit that transmits and receives electrical signals to and from the bus.

In order to detect hydrogen leakage, hydrogen sensors typically make use of the notable thermal conductivity difference between normal air and air containing hydrogen. The sensors may be directly connected to data bus 3, as in FIG. 1, or via a controller.

If hydrogen sensors 5, 6 detect a leak, the analog fault signal is converted to a digital signal by the analog-digital converter and is transferred to data bus 3. Controllers 4, 8, 9, 10 and sensors 5, 6 receive this information and disconnect themselves from data bus 3. With the area of leakage assumed here to be fuel zone 1 and data bus 3 extending though such zone, only controllers and sensors which are current-carrying units for data bus 3 (i.e., controllers 4, 8, 9, 10 and sensors 5, 6) are disconnected. Current-carrying units are units of a data bus that deliver electrical signals to or receive electrical signals from such data bus (such as for example controllers or sensors). Included as current-carrying units are also the power supplies of the units connected to the data bus, such as for example voltage regulators that supply power to the various elements of a controller and/or sensor. At the same time controllers 4, 8, 9, 10 and sensors 5, 6 disconnect themselves from data bus 3, the transmitting/receiving units of such controllers and sensors are either de-energized or turned off.

With controllers 4, 8, 9, 10 and sensors 5, 6 being electrically disconnected from the data bus lines of data bus 3, and their transmitting/receiving units being either de-energized or turned off, the supply of electrical power to data bus 3 ceases.

It should be noted that the decoupling of controller 10 from data bus 3 does not affect the ability of other controllers and/or sensors, connected to data bus 11, from continuing to operate. The same method can also be applied to a data bus system configured in a star pattern. In such a configuration, individual branches of the star can be disconnected electrically from the rest of the current-carrying units of the star or data bus system by a coupler in the centre. This makes it possible to electrically disconnect certain areas of the data bus without having to disconnect the entire data bus. The area to be disconnected is identified by identifying the current-carrying units of the data bus in the area of the leak.

In addition, controllers and sensors located in the area of leakage should not be a source of additional electrical energy. In FIG. 1, because fuel zone 1 is the area of leakage, controller 4 and the sensors 5, 6 turn off their respective voltage regulators, and thus themselves.

As a result, electrical energy, which could set-off or ignite a flammable gas, is no longer present in the area of the leakage or fuel zone 1. Moreover, controllers 8, 9, 10, which are located outside of fuel zone 1, do not have to be turned off, which allows for a more rapid reactivation of the data bus after the leak has been dealt with.

Any remaining electrical energy in the data lines of data bus 3 or electrical energy, that is introduced by external electromagnetic fields, e.g., by radar stations, can be eliminated by means of an additional circuit. For this purpose, at least one of the lines of data bus 3 is connected to the chassis ground of the vehicle in a controller, preferably in normal zone 2, to ensure that this electrical energy is dissipated at this location.

It is also possible for an input/output unit to be connected, via data bus 3 or directly, to a controller 9 outside of fuel zone 1, whereby in the event of a leak this input/output unit immediately issues an alert to the driver of the vehicle, who can then initiate the appropriate measures.

It should be noted that the reactivation of data bus system 3 should only occur once the concentration of flammable gas within the fuel zone 1 has dropped to an acceptable level. To verify this, a testing device can be used. If the concentration of flammable gas within the fuel zone 1 has dropped to an acceptable level, then a testing device coupled to data bus 3 could send an enable signal to data bus 3, which could serve as a control signal to be used when controllers 4, 8, 9, 10 and sensors 5, 6 are reconnected to the system.

Fuel zone 1 represents the zone in which possible leak of a flammable gas can occur. This may be the zone around the hydrogen tank, as illustrated in this embodiment; however, the area around other system components, such as for example the fuel processing system or the battery system, may also represent fuel zones. These fuel zones can either be monitored by a common data bus 3 or by several independently installed data busses.

The area of the leakage does not have to be confined to the fuel zone, as is the case in this embodiment. However, fuel zone 1 typically corresponds to the area of the leakage, since fuel zone 1 is often provided with containment measures to ward against gas discharges outside such fuel zone. In the current embodiment, fuel zone 1 corresponds to a separate compartment in the vehicle that is sealed gas-tight from other compartments of the vehicle, e.g., normal zone 2.

It is therefore contemplated by the appended claims to cover such modifications as incorporate those features, which come within the scope of the invention.

What is claimed is:

1. Method of operating an electrical data bus system which controls at least one monitoring device for detecting a flammable gas leak within a fuel zone, wherein upon a flammable gas leak within the fuel zone being detected, the flow of electrical current in the fuel zone via the data bus system or any device connected to the data bus system is prevented.

2. The method of claim 1, wherein the step of preventing the flow of electrical current in the fuel zone comprises disconnecting, from the data bus, monitoring devices, which deliver electrical signals to or receive electrical signals from the data bus.

3. The method of claim 1, wherein the step of preventing the flow of electrical current in the fuel zone comprises having the monitoring devices, which deliver electrical signals to or receive electrical signals from the data bus, disconnect themselves from the data bus.

4. The method of claim 1, wherein the step of preventing the flow of electrical current in the fuel zone comprises grounding the data bus.

5. The method of claim 1, wherein the step of preventing the flow of electrical current in the fuel zone comprises disconnecting monitoring devices, located within the fuel zone, from their power supply.

6. The method of claim 1, wherein the step of preventing the flow of electrical current in the fuel zone comprises turning off the power supply of monitoring devices located within the fuel zone.

7. The method of claim 4, wherein the step of preventing the flow of electrical current in the fuel zone further comprises disconnecting monitoring devices, located within the fuel zone, from their power supply.

8. The method of claim 4, wherein the step of preventing the flow of electrical current in the fuel zone further comprises turning off the power supply of monitoring devices located within the fuel zone.

9. The method of claim 2, further comprising the step of testing the level of flammable gases within the fuel zone before reconnecting the monitoring devices to the data bus.

10. The method of claim 5, further comprising the step of testing the level of flammable gases within the fuel zone before reconnecting the monitoring devices, located within the fuel zone, to their power supply.

11. The method of claim 6, further comprising the step of testing the level of flammable gases within the fuel zone before turning the power supply of the monitoring devices located within the fuel zone back on.

12. A computer program product with program code stored on a machine-readable carrier for executing the method according to any of claims 1 to 11 when the program is running on a computer.

13. A digital storage medium with control signals that can be read out electronically, the control signals being able to interact and/or cooperate with a programmable computer system such that a method according to any of claims 1 to 11 is carried out.

14. An apparatus for detecting a flammable gas leak within a fuel zone, comprising:
an electrical data bus system; and
a monitoring device, delivering electrical signals to or receiving electrical signals from the data bus system, for detecting a flammable gas leak within the fuel zone,
and configured so that upon a flammable gas leak within the fuel zone being detected, the flow of electrical current in the fuel zone is prevented.

15. The apparatus of claim 14, further comprising a control device, connected to the data bus system, for disconnecting, from the data bus, the monitoring device.

16. The apparatus of claim 15, wherein the control device prevents the monitoring device from being re-connected to the data bus system until the concentration of flammable gas within the fuel zone is at an acceptable level.

17. The apparatus of claim 14, wherein the monitoring device is configured to disconnect itself from the data bus system.

18. The apparatus of claim 17, further comprising a control device, connected to the data bus system, for preventing the monitoring device from re-connecting itself to the data bus system until the concentration of flammable gas within the fuel zone is at an acceptable level.

19. The apparatus of claim 14, further comprising a control device, connected to the data bus system, for grounding the data bus system.

20. The apparatus of claim 14, further comprising a control device, connected to the data bus system, for disconnecting the monitoring device from its power supply

21. The apparatus of claim 20, wherein the control device prevents the monitoring device from being re-connected to its power supply until the concentration of flammable gas within the fuel zone is at an acceptable level.

22. The apparatus of claim 14, wherein the monitoring device can turn off its power supply.

23. The apparatus of claim 22, further comprising a control device, connected to the data bus system, for preventing the monitoring device from turning on their power supply until the concentration of flammable gas within the fuel zone is at an acceptable level.
